(19) United States
(12) Patent Application Publication
(10) Pub. No.: US 2022/0243910 A1
(43) Pub. Date: Aug. 4, 2022

(54) SYSTEM AND METHOD FOR CALCINING COAL GANGUE

(71) Applicant: XINQIAN SHU, Beijing (CN)

(72) Inventors: Xinqian Shu, Beijing (CN); Yuanfeng Shu, Beijing (CN); Xize Zhang, Beijing (CN)

(73) Assignee: XINQIAN SHU, Beijing (CN)

(21) Appl. No.: 17/589,272

(22) Filed: Jan. 31, 2022

(30) Foreign Application Priority Data
Feb. 3, 2021 (CN) 202110148991.8

(51) Int. Cl. F23B 30/00; B01D 46/02; B01D 53/60; F23K 1/00

(52) U.S. Cl. CPC F23B 1/16; B01D 46/02; F23K 2201/30; F23K 1/00; F23K 2201/1006; B01D 53/60

(57) ABSTRACT

The present disclosure provides a system and a method for calcining coal gangue, which belongs to the technical field of coal gangue treatment and resource utilization. The system for calcining coal gangue provided by the present disclosure includes a pretreatment system (1), a crusher (4), a screening system (5), an elevator (6-1), a screw feeder (6-2 ), a rotary kiln (7), and an exhaust gas treatment system (8). The crusher 4 includes a hammer crusher or an impact crusher. The screening system 5 includes a flip-flow screen or a vibrating screen. Both the flip-flow screen and the vibrating screen are of double-layer screen mesh structures. The mesh size of an upper-layer screen f a double-layer screen mesh structure is 25 mm, and the mesh size of a lower-layer screen of the double-layer screen mesh structure is 0.5 mm.

### CROSS REFERENCE TO RELATED APPLICATION

This patent application claims the benefit and priority of Chinese Patent Application No. 202110148991.8, filed on Feb. 3, 2021, the disclosure of which is incorporated by reference herein in its entirety as part of the present application.

### TECHNICAL FIELD

The present disclosure relates to the technical field of coal gangue treatment and resources utilization, and in particular, to a system and method for calcining coal gangue.

### BACKGROUND ART

Coal gangue is a solid wastes discharged in the processes of coal mining and coal preparation. It is a rock which is associated with a coal seam, is low in carbon content, and is harder than coal. The coal gangue has the main components of SiO₂ and Al₂O₃, and also contains different amounts of Fe₂O₃, CaO, MgO, Na₂O, K₂O, and trace rare elements (like titanium, gallium, vanadium, and cobalt, etc.). The coal gangue is a mixture consisting of coal and various inorganic minerals. The minerals in the coal gangue are good raw materials, auxiliary materials, and additive materials of cement and various building materials. The coal in the coal gangue can be separated or combusted in a reasonable way; and the remaining coal gangue can be well used as building materials, inorganic mineral raw materials or functional materials. Therefore, a research on a resource utilization technology of calcination of the coal gangue was carried out.

For example, Chinese Patent CN1718556A discloses a precalcining kiln bypass ventilation and coal gangue dehydration process, which is to grind coal gangue below 0.08 mm, and to perform drying and calcining treatment on the coal gangue by using high-temperature flue gas formed by the precalcining kiln bypass ventilation, and to perform treatment on harmful volatile components in the flue gas. Chinese Patent CN103864325A discloses a production system for continuously calcining coal gangue in a suspended state, which is to grind the coal gangue below 0.075 mm, and then to perform cooling and discharging on materials through multi-stage feeding and a cyclone. The system can perform coal gangue calcination stably and continuously, and exhaust gas is effectively purified. It can be seen that the abovementioned calcination process generally needs to grind the coal gangue to a relatively fine particle size, so not only crushing treatment of raw materials and a calcination process structure are complex, but also the energy consumption of the calcination process is relatively high.

### SUMMARY

In view of this objective of the present disclosure is to provide a system and a method for calcining coal gangue. Fuel does not need to be added during calcining the coal gangue by using the device provided by the present disclosure, whereas the coal gangue is completely calcined by using the heat of the coal gangue itself. A calcination process is relatively simple, the energy loss is low, and secondary pollution cannot be caused.

To achieve the abovementioned objective, the present disclosure provides the following technical solutions,

The present disclosure provides a system for calcining coal gangue, including a pretreatment system 1;

a crusher 4 with a feeding port communicated with a discharging port of the pretreatment system 1;

a screening system 5 with a feeding port communicated with a discharging port of the crusher 4;

an elevator 6-1 with a feeding port communicated with a medium size of coal gangue discharging port 5-1 and a small size of coal gangue discharging port 5-2 of the screening system 5;

a screw feeder 6-2 with a feeding port communicated with a discharging port of the elevator 6-1;

a rotary kiln 7 with a feeding port communicated with a discharging port of the screw feeder 6-2; and

an exhaust gas treatment system 8 with a flue gas inlet communicated with a flue gas outlet of the rotary kiln 7.

The crusher 4 includes a hammer crusher or an impact crusher,

The screening system 5 includes a flip-flow screen or a vibrating screen. Both the flip-flow screen and the vibrating screen are of double-layer screen mesh structures. The mesh size of an upper-layer screen mesh of a double-layer screen mesh structure is 25 mm, and the mesh size of a lower-layer screen mesh of the double-layer screen mesh structure is 0.5 mm.

Preferably, the flue gas outlet of the rotary kiln 7 is communicated with each of the flue gas inlet of the rotary kiln 7 and the flue gas inlet of the pretreatment system 1.

The length-to-diameter ratio of the rotary kiln 7 is 25 to 45.

Preferably, the system further includes a first cooler 9 with a feeding port communicated with a discharging port of the rotary kiln 7;

a chain plate conveyor 10 with a feeding port communicated with a discharging port of the first cooler 9; and

a calcined coal gangue product bin 11 with a feeding port communicated a discharging port of the chain plate conveyor 10.

Preferably, the exhaust gas treatment system 8 includes a second cooler 8-1, a bag-type dust collector 8-2 with a flue gas inlet communicated with the second cooler 8-1, a desulfurization and denitration system 8-3 with a flue gas inlet communicated with the flue gas outlet of the bag-type dust collector 8-2, a chimney 8-4 with a flue gas inlet communicated with the desulfurization and denitration system 8-3, and a dust bin 8-5 communicated with a discharging port of the bag-type dust collector 8-2.

A flue gas outlet of the cooler 8-1 is communicated with each of the flue gas outlet of the pretreatment system 1 and the flue gas outlet of the rotary kiln 7.

The present disclosure provides a method for calcining coal gangue by using the system in the abovementioned technical solution, including the following steps:

conveying coal gangue to the pretreatment system 1 for performing pretreatment to obtain pretreated coal gangue;

crushing the preheated coal gangue in the crusher 4 to obtain crushed coal gangue:

conveying the crushed coal gangue into the screening system 5 for screening to obtain large size of coal gangue, medium size of coal gangue, small size of coal gangue, where the particle size of the large size of coal gangue is greater than 25 mm, the particle size of the medium size of coal gangue is 0.5 to 25 mm, and the particle size of the small size of coal gangue is less than 0.5 mm;

batching and mixing the medium size of coal gangue and the small size of coal gangue through the elevator 6-1, and conveying the mixture to the screw feeder 6-2, and then calcining the mixture in the rotary kiln 7 to obtain calcined coal gangue and flue gas, where the flue gas is exhausted after being purified to reach a discharge standard through the exhaust gas treatment system 8.

Preferably, the moisture of the pretreated coal gangue is less than or equal to 5%.

Preferably, when the Hardgrove Grindability Index (HCI) of the coal gangue is greater than or equal to 50, the crusher 4 selects a hammer crusher,

When the Hardgrove grindability index of the coal gangue is less than 50, the crusher 4 selects an impact crusher.

Preferably, when the index of plasticity (Ip) of the coal gangue is greater than 10, the screening system 5 selects a flip-flow screen.

When the Ip of the coal gangue is less than or equal to 10, the screening system 5 selects a vibrating screen.

Preferably, ingredients are determined according to the calorific value of the coal gangue, which is as follows specifically:

when the calorific value of the coal gangue is 400 to 550 kC/kg, the addition amount of the small size of coal gangue accounts for 80 to 100% of the total mass of the small size of coal gangue;

when the calorific value of the coal gangue is 551 to 700 kC/kg, the addition amount of the small size of coal gangue accounts for 50 to 75% of the total mass of the small size of coal gangue;

when the calorific value of the coal gangue is 701 to 850 kC/kg, the addition amount of the small coal gangue accounts for 25 to 50% of the total mass of the small size of coal gangue; and

when the calorific value of the coal gangue is greater than 850 kC/kg, the addition amount of the small size of coal gangue is 0.

Preferably, the calcination temperature is 950 to 1100° C., and the calcination time is 50 to 65 min.

The calcination atmosphere is air, and the molar ratio of oxygen in the air to the content of fixed carbon in the coal gangue is (1.25 to 1.50):1.

The loss on ignition of the calcined coal gangue is less than or equal to 8.5%.

A filling coefficient of the coal gangue in the rotary kiln 7 is 12 to 25%.

The present disclosure provides a system for calcining coal gangue, including a pretreatment system 1; a 4 with a feeding port communicated with a discharging port of the pretreatment system 1; a screening system 5 with a feeding port communicated with a discharging port of the crusher 4; an elevator 6-1 with a feeding port communicated with a medium size of coal gangue discharging port 5-1 and a small size of coal gangue discharging port 5-2 of the screening system 5; a screw feeder 6-2 with a feeding port communicated with a discharging port of the elevator 8-1; a rotary kiln 7 with a feeding port communicated with a discharging port of the screw feeder 6-2; and an exhaust gas treatment system 8 with a flue gas inlet communicated with a flue gas outlet of the rotary kiln 7. The crusher 4 includes a hammer crusher or an impact crusher. The screening system 5 includes a flip-flow screen or a vibrating screen, Both the flip-flow screen and the vibrating screen are of double-layer screen mesh structures. The mesh size of an upper-layer screen of a double-layer screen mesh structure is 25 mm, and the mesh size of a lower-layer screen of the double-layer screen mesh structure is 0.5 mm. The system provided by the present disclosure is suitable for calcining the coal gangue with the particle size less than 25 mm, and the particle size of the treated coal gangue is wide, which can meet the requirements for calcining the coal gangue in different industries. According to the present disclosure, calcination is performed by using the heat from the coal gangue without additional fuel addition, and the energy consumption of a treatment process is relatively low; and furthermore, the calcination flue gas will not cause secondary pollution to the environment after being treated by a post-treatment system.

The present disclosure provides a method for calcining the coal gangue by using the abovementioned system, including the following steps: conveying coal gangue to the pretreatment system 1 for performing pretreatment to obtain pretreated coal gangue; crushing the pretreated coal gangue in the crusher 4 for crushing to obtain crushed coal gangue; conveying the crushed coal gangue into the screening system 5 for screening to obtain large size of coal gangue, medium size of coal gangue, small size of coal gangue, where the particle size of the large size of coal gangue is greater than 25 mm, the particle size of the medium size of coal gangue is 0.5 to 25 mm, and the particle size of the small size of coal gangue is less than 0.5 mm; and batching and mixing the medium size of coal gangue and the small size of coal gangue through the elevator 6-1, and conveying the mixture to the screw feeder 6-2, and then calcining the mixture in the rotary kiln 7 to obtain calcined coal gangue and flue gas; and discharging the flue gas after being purified to reach a discharge standard through the exhaust gas treatment system 8. According to the method provided by the present disclosure, the coal gangue does not need to be finely ground, but the coal gangue only needs to be crushed below 25 mm for performing calcination, so that the method has strong adaptability to the particle size of the coal gangue. In addition, according to the method provided by the present disclosure, only the heat from the coal gangue is used for calcining without additional fuel, so the energy consumption is relatively low. Moreover, the calcination flue gas will not cause secondary pollution to the environment after being purified by the post-treatment system.

### BRIEF DESCRIPTION OF THE DRAWINGS

FIG. 1 is a diagram of a system for calcining coal gangue, in which 1 is a pretreatment system, 2 is a raw material bin, 2-1 is a belt conveyor, 3 is a feeding system, 4 is a crusher, 5 is a screening system, 5-1 is a medium size of coal gangue discharging port, 5-2 is a small size of coal gangue discharging port, 5-3 is a large size of coal gangue discharging port, 6-1 is an elevator, 6-2 is a screw feeder, 7 is a rotary kiln, 8 is an exhaust gas treatment system, 8-1 is a second cooler, 8-2 is a bag-type dust collector, 8-3 is a desulfurization and denitration system, 8-4 is a chimney, 8-5 is a dust bin, 9 is a first cooler, 10 is a chain plate conveyor, 11 is a calcined coal gangue product bin, 12-1 is a first flue gas pipeline, 12-2 is a second flue gas pipeline, 12-3 is a third flue gas pipeline, 12-4 is a fourth flue gas pipeline, 12-5 is a fifth flue gas pipeline, 12-6 is a sixth flue gas pipeline, 12-7 is a seventh flue gas pipeline, 13-1 is a first fan, 13-2 is a second fan, 13-3 is a third fan, 13-4 is a fourth fan, 13-5 is a fifth fan, and 14 is a valve.

### DETAILED DESCRIPTION OF THE EMBODIMENTS

The present disclosure provides a system for calcining coal gangue, including a pre-treatment system 1;

a crusher with a feeding port communicated with a discharging port of the pretreatment system 1;

a screening system 5 with a feeding port communicated with a discharging port of the crusher 4;

an elevator 6-1 with a feeding port communicated with a medium coal gangue discharging port 5-1 and a small size of coal gangue discharging port 5-2 of the screening system 5;

a screw feeder 6-2 with a feeding port communicated with a discharging port of the elevator 8-1;

a rotary kiln 7 with a feeding port communicated with a discharging port of the screw feeder 6-2; and

an exhaust gas treatment system 8 with a flue gas inlet communicated with a flue gas outlet of the rotary kiln 7.

The crusher 4 includes a hammer crusher or an impact crusher.

The screening system 5 includes a flip-flow screen or a vibrating screen. Both the flip-flow screen and the vibrating screen are of double-layer screen mesh structures, The mesh size of an upper-layer screen of a double-layer screen mesh structure is 25 mm, and the mesh size of a lower-layer screen of the double-layer screen mesh structure is 0.5 mm.

In the present disclosure, the system includes the pretreatment system 1. The present disclosure does not have particular limitation on the pretreatment system 1, as long as it can dehydrate and dry the coal gangue. The moisture of the dehydrated and dried coal gangue is less than or equal to 5%. In the present disclosure, heat for the pretreatment system 1 is from the flue gas generated after the coal gangue is calcined in the rotary kiln 7.

In an embodiment of the present disclosure, the system further includes a raw material bin 2 with a feeding port communicated with a discharging port of the pretreatment system 1. In an embodiment of the present disclosure, the raw material bin is a vertical silo. The raw material bin 2 has the effects of performing preliminary mixing and homogenizing on the coal gangue, and meanwhile storing the coal gangue. In an embodiment of the present disclosure, the capacity of the raw material bin 2 is 3 to 4 times the daily treatment capacity of the coal gangue when the coal gangue is calcined by means of the system of the present disclosure.

In an embodiment of the present disclosure, the system further includes a feeding system 3 with a feeding port communicated with a discharging port of the raw material bin 2. In the present disclosure, the feeding system 3 is provided with a metering device for calculating the amount of the input coal gangue to ensure stable and continuous feeding of the coal gangue. In an embodiment of the present disclosure, the discharging port of the raw material bin 2 is communicated with the feeding port of the feeding system 3 through a belt conveyor 2-1.

In the present disclosure, the system further includes a crusher 4 communicated with a discharging port of the feeding system 3. In the present disclosure, the crusher 4 includes a hammer crusher or an impact crusher.

In the present disclosure, the system further includes a screening system 5 with a feeding port communicated with the discharging port of the crusher 4. A medium size of coal gangue discharging port 5-1, a small size of coal gangue discharging port 5-2, and a large size of coal gangue discharging port 5-3 are formed in the screening system 5. In the present disclosure, the screening system 5 further includes a flip-flow screen or a vibrating screen. Both the flip-flow screen and the vibrating screen are of double-layer screen mesh structures. The mesh size of an upper-layer screen of a double-layer screen mesh structure is 25 mm, and the mesh size of a lower-layer screen of the double-layer screen mesh structure is 0.5 mm. In an embodiment of the present disclosure, the coal gangue with the particle size of greater than 25 mm after being screened by the screening system 5 is conveyed into the crusher 4 for secondary crushing through the large size of coal gangue discharging port 5-3 of the screening system 5. In an embodiment of the present disclosure, small size of coal gangue with the particle size of less than 0.5 mm enters into a coal bin after being screened through the screening system 5.

In the present disclosure, the system further includes an elevator 6-1 with a feeding port communicated with a medium size of coal gangue discharging port 5-1 and a small size of coal gangue discharging port 5-2 of the screening system 5. In the present disclosure, a metering device is arranged on a pipeline communicated with the medium coal gangue discharging port 5-1 and the elevator 6-1, and is used for metering the amount of medium size of coal gangue; and a metering device is arranged on a pipeline communicated with the small size of coal gangue discharging port 5-2 and the elevator 6-1, and is used for calculating the amount of small size of coal gangue.

In the present disclosure, the system further includes a screw feeder 6-2 with a feeding port communicated with a discharging port of the elevator 6-1. In an embodiment of the present disclosure, a feeding port of the rotary kiln 7 is communicated with a feeding port of the screw feeder 6-2. In an embodiment of the present disclosure, the length-to-diameter ratio of the rotary kiln 7 is preferably 25 to 45. The definition of the length-to-diameter ratio K_{L} is as shown in Formula (1/

$${K}_{L =} \frac{L}{D} = \frac{effective length of cylinder body}{average inner diameter of cylinder body} . \qquad ( 1 )$$

In the present disclosure, the rotating speed of the rotary kiln is preferably 0.5 to 3 r/min, more preferably, 0.5 to 2.5 r/min, and most preferably, 0.5 to 2 r/min.

In an embodiment of the present disclosure, a flue gas outlet of the rotary kiln 7 is communicated with a flue gas inlet of the rotary kiln 7 through a first flue gas pipeline 12-1 and a second flue gas pipeline 12-2. A first fan 13-1 is arranged on the first flue gas pipeline 12-1. In an embodiment of the present disclosure, the flue gas generated by the rotary kiln 7 is circulated into the rotary kiln 7 through the first flue gas pipeline 12-1 and the first fan 13-1 to heat the coal gangue.

In an embodiment of the present disclosure, the flue gas outlet of the rotary kiln 7 is communicated with the flue gas inlet of the pretreatment system 1. In an embodiment of the present disclosure, the flue gas outlet of the rotary kiln 7 is communicated with the flue gas inlet of the pretreatment system 1 through the third flue gas pipeline 12-3. A second fan 13-2 is arranged on the third flue gas pipeline 12-3. In an embodiment of the present disclosure, the flue gas generated by the rotary kiln 7 is drawn back to the pretreatment system 1 through the third flue gas pipeline 12-3 and the second fan 13-2, so as to provide heat for dehydrating and drying the coal gangue.

In the present disclosure, the system further includes an exhaust gas treatment system 8 with a flue gas inlet communicated with the flue gas outlet of the rotary kiln 7. In an embodiment of the present disclosure, the exhaust gas treatment system 8 includes a second cooler 8-1, a bag-type dust collector 8-2 with a flue gas inlet communicated with the second cooler 8-1, a desulfurization and denitration system 8-3 with a flue gas inlet communicated with the flue gas outlet of the bag-type dust collector 8-2, a chimney with a flue gas inlet communicated with the desulfurization and denitration system 8-3, and a dust bin 8-5 communicated with a discharging port of the bag-type dust collector 8-2. A flue gas inlet of the second cooler 8-1 is communicated with each of the flue gas outlet of the pretreatment system 1 and the flue gas outlet of the rotary kiln 7.

In an embodiment of the present disclosure, the flue gas generated by the pretreatment system 1 and the flue gas generated by the rotary kiln 7 are collected to enter into the first cooler 8-1 for performing cooling treatment. In an embodiment of the present disclosure, the flue gas outlet of the rotary kiln 7 is communicated with a flue gas inlet of the first cooler 8-1 through the first flue gas pipeline 12-1 and the fourth flue gas pipeline 12-4. A valve 14 and a third fan 13-3 are arranged on the fourth flue gas pipeline 12-4. In an embodiment of the present disclosure, a flue gas monitoring device is arranged on the first flue gas pipeline 12-1, and is used for detecting the composition of the flue gas produced by the rotary kiln 7. When the concentration of harmful components in the flue gas exceeds a pre-warning value, the valve 14 on the fourth flue gas pipeline 12-4 is opened, and the flue gas is drawn back into the first cooler 8-1 through the fourth flue gas pipeline 12-4 and the third fan 13-3. In an embodiment of the present disclosure, the flue gas of the pretreatment system 1 is communicated with the flue gas inlet of the first cooler 8-1 through the fifth flue gas pipeline 12-5 and the third fan 13-3. In the present disclosure, the cooler has an effect of cooling the flue gas.

In an embodiment of the present disclosure, the flue gas inlet of the bag-type dust collector 8-2 is communicated with the first cooler 8-1. A discharging port of the bag-type dust collector 8-2 is communicated with the dust bin 8-5. In the present disclosure, the bag-type dust collector 8-2 has an effect of filtering dust particles in the flue gas, and the dust trapped by the bag-type dust collector 8-2 enter into the dust bin 8-5.

In an embodiment of the present disclosure, the flue gas inlet of the bag-type dust collector 8-2 is communicated with the flue gas inlet of the desulfurization and denitration system 8-3 through a sixth flue gas pipeline 12-6. A fourth fan 13-4 is arranged on the sixth flue gas pipeline 12-6. In an embodiment of the present disclosure, the desulfurization and denitration system 8-3 has an effect of performing desulfurization and denitration treatment on the flue gas.

In an embodiment of the present disclosure, the flue gas outlet of the desulfurization and denitration system 8-3 is communicated with a flue gas inlet of a chimney 8-4 through a seventh flue gas pipeline 12-7. A fifth fan 13-5 is arranged on the seventh flue gas pipeline 12-7.

In an embodiment of the present disclosure, the system further includes a second cooler 9 communicated with the flue gas outlet of the rotary kiln 7. In the present disclosure, the second cooler 9 is used for cooling the calcined coal gangue obtained after the calcination of the rotary kiln 7.

In an embodiment of the present disclosure, the system further includes a chain plate conveyor 10 with a feeding port communicated with the discharging port of the second cooler 9. In the present disclosure, the chain plate conveyor 10 has an effect of conveying the calcined coal gangue after being cooled by the coolers.

In an embodiment of the present disclosure, the system further includes a calcined coal gangue product bin 11 with a feeding port communicated with a discharging port of the chain plate conveyor 10. In an embodiment of the present disclosure, a detection device is arranged between the chain plate conveyor 10 and the calcined coal gangue product bin 11, which detects to obtain an index of the loss on ignition of the calcined coal gangue. The calcined coal gangue is a qualified product with the loss on ignition of less than or equal to 8.5%. The qualified calcined coal gangue is conveyed into the calcined coal gangue product bin 11 for storing. When the loss on ignition of the calcined coal gangue does not meet the requirement of less than or equal to 8.5%, the present disclosure preferably adjusts the calcination temperature and time, so as to meet the requirement of the qualified product of the calcined coal gangue.

The present disclosure provides a method for calcining coal gangue by using the abovementioned system, including the following steps,

Coal gangue is conveyed to the pretreatment system 1 for performing pretreatment to obtain pretreated coal gangue.

The pretreated coal gangue is conveyed into the crusher 4 for crushing to obtain crushed coal gangue.

The crushed coal gangue is conveyed into the screening system 5 for screening to obtain large size of coal gangue, medium size of coal gangue, small size of coal gangue, where the particle size of the large size of coal gangue is greater than 25 mm, the particle size of the medium size of coal gangue is 0.5 to 25 mm, and the particle size of the small size of coal gangue is less than 0.5 mm.

The medium size of coal gangue and the small size of coal gangue are mixed through the elevator 6-1 after being batched, and the mixture is conveyed to the screw feeder 6-2, and then the mixture is calcined in the rotary kiln 7 to obtain calcined coal gangue and flue gas. The flue gas is exhausted after being purified to reach a standard through the exhaust gas treatment system 8.

According to the present disclosure, the coal gangue is conveyed to the pretreatment system 1 for performing pretreatment to obtain pretreated coal gangue. The present disclosure does not have particular attention on where the coal gangue comes from, as long as the coal gangue has the calorific value of 400 to 1000 kC/kg. In the present disclosure, the pretreatment preferably includes dehydrating and drying. The heat for dehydrating and drying is preferably from the flue gas generated by the calcination of the rotary kiln 7. The present disclosure does not have particular limitation on the conditions for dehydrating and drying, and just to meet the moisture of the pretreated coal gangue no larger than or equal to 5%.

After the pretreated coal gangue is obtained, the pretreated coal gangue is conveyed into the crusher 4 for crushing to obtain crushed coal gangue.

Before crushing, the present disclosure preferably includes that the pretreated coal gangue is conveyed into the raw material bin 2 for mixing, and then is metered through a feeding system 3 and is conveyed into the crusher 4 for crushing to obtain crushed coal gangue.

In the present disclosure, the crushing manner of the coal gangue is preferably selected according to the (HGI) of the coal gangue. Specifically, when the HGI of the coal gangue is greater than or equal to 50, a hammer crusher is preferably used for crushing. When the HGI of the coal gangue is less than 50, an impact crusher is preferably used for crushing.

After the crushed coal gangue is obtained, the crushed coal gangue is conveyed into the screening system 5 for screening to obtain the large size of coal gangue, the medium size of coal gangue, the small size of coal gangue, where the particle size of the large size of coal gangue is greater than 25 mm, the particle size of the medium size of coal gangue is 0.5 to 25 mm, and the particle size of the small size of coal gangue is less than 0.5 mm. In the present disclosure, the large size of coal gangue is preferably conveyed into the crusher for performing secondary crushing. In the present disclosure, a screen used by the screening system is selected according to the Ip of the coal gangue. Specifically, when the Ip of the coal gangue is greater than 10, a flip-flow screen is preferably used for screening; and when the Ip of the coal gangue is less than or equal to 10, a vibrating screen is preferably used for screening.

After the medium size of coal gangue and the small size of coal gangue are obtained, the medium size of coal gangue and the small size of coal gangue are mixed and elevated to the screw feeder 6-2 through the elevator 6-1 after being batched, and the mixture enters into the rotary kiln 7 for calcining, so as to obtain calcined coal gangue and flue gas. The flue gas is exhausted after being purified to reach a discharge standard through the exhaust gas treatment system 8.

In the present disclosure, ingredients are preferably determined according to the calorific value of the coal gangue. Specifically, when the calorific value of the coal gangue is 400 to 550 kC/kg, the addition amount of the small size of coal gangue preferably accounts for 80 to 100% of the total mass of the small size of coal gangue, more preferably, 80 to 95%, and most preferably, 80 to 90%; when the calorific value of the coal gangue is 551 to 700 kC/kg, the addition amount of the small size of coal gangue preferably accounts for 50 to 75% of the total mass of the small size of coal gangue, more preferably, 50 to 70%, and most preferably, 60 to 65%; when the calorific value of the coal gangue is 70% to 850 kC/kg, the addition amount of the small size of coal gangue preferably accounts for 25 to 50% of the total mass of the small size of coal gangue, more preferably, 25 to 45%, and most preferably, 25 to 40%; and when the calorific value of the coal gangue is greater than 850 kC/kg, the addition amount of the small size of coal gangue is preferably 0.

In the present disclosure, the calcination temperature is preferably 950 to 1100° C., and more preferably 950 to 1050° C. The calcination time is preferably 50 to 65 min, and more preferably 50 to 60 min. In the present disclosure, the temperature rises from room temperature to the calcination temperature through a first calcination stage and a second calcination stage in sequence. In the present disclosure, in the first calcination stage, the room temperature rises to a about 500° C. The first calcination is preferably at 500° C. The time of the first calcination stage is preferably 20 to 30 min, and more preferably 20 to 25 min. The first calcination stage is mainly to remove volatiles (moisture) from the coal gangue. In the present disclosure, in the second calcination stage, the temperature rises to higher temperature. The second calcination stage is preferably at the temperature of 550 to 750° C., more preferably at 560 to 750° C., and most preferably at 565 to 750° C. The time for the second calcination stage is preferably 5 to 15 min, and more preferably 5 to 10 min. The second calcination stage is mainly to convert and stabilize the structures of mineral substances, such as quartz and clay minerals, in the coal gangue. Then, the temperature rises to 950 to 1100° C., so as to perform a third calcination stage on the coal gangue.

After the calcination, a calcination system is preferably cooled. The cooling temperature is preferably 500 to 850° C., and more preferably, 500 to 800° C. The cooling time is preferably 10 to 20 min, and more preferably 15 to 20 min.

In the present disclosure, the calcination atmosphere is preferably air, and the molar ratio of oxygen in the air to the content of fixed carbon in the coal gangue is (1.25 to 1.50):1, more preferably, (1.25 to 1.45):1, and most preferably, (1.25 to 1.40):1. In the present disclosure, the flowing speed of the air is preferably 2.0 to 4.5 m/s, more preferably, 2.0 to 4.2 m/s, and most preferably 2.0 to 4.0 m/s.

In the present disclosure, a filling coefficient (ρ) of the coal gangue in the rotary kiln 7 is 12 to 25%, more preferably, 15 to 20%. The filling coefficient of the rotary kiln refers to a ratio of a cross-sectional area of the rotary kiln occupied by the materials to the clearance cross-sectional area of the rotary kiln.

The calcined coal gangue is cooled through the second cooler 9 and is conveyed into the calcined coal gangue product bin 11 through the chain plate conveyor 10. In the present disclosure, the flue gas is preferably reused in the pretreatment system for dehydrating and drying the coal gangue and heating raw materials in the rotary kiln 7. The flue gas generated by dehydrating and drying and the flue gas with the concentration of harmful components generated by the rotary kiln 7 exceeds the pre-warning value is preferably cooled by the first cooler 8-1, subjected to dust removal through the bag-type dust collector 8-2, and subjected to desulfurization and denitration through the desulfurization and denitration system 8-3 in sequence, and is exhausted through the chimney 8-4 after reaching a discharge standard. The dust particles removed by the bag-type dust collector 8-2 enter the dust bin 8-5.

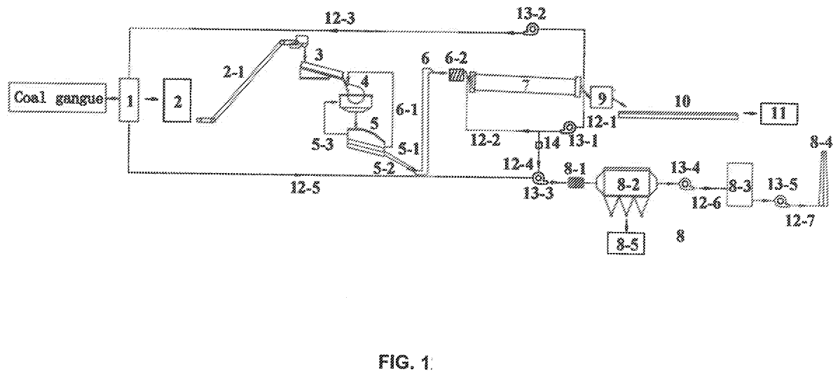

A specific method for calcining the coal gangue by using the system for calcining the coal gangue provided by the present disclosure is described below in combination with FIG. 1. The method includes the following steps: coal gangue is conveyed to the pretreatment system 1 for performing pretreatment to obtain pretreated coal gangue and flue gas. The pretreated coal gangue is conveyed into the raw material bin 2 for mixing, homogenizing, and storing, so as to obtain homogenized coal gangue. The homogenized coal gangue is conveyed to the feeding system 3 for metering through a belt conveyor 2-1, and then is conveyed into the crusher 4 for crushing to obtain crushed coal gangue. The crushed coal gangue is conveyed into the screening system 5 for screening to obtain large size of coal gangue, medium size of coal gangue, small size of coal gangue, where the large size of coal gangue is conveyed into the crusher 4 for performing secondary crushing. The medium size of coal gangue and the small size of coal gangue are mixed and elevated to the screw feeder 6-2 through the elevator 6-1 after being batched, then the mixture enters the rotary kiln 7 for calcining, and is cooled by the second cooler 9 and is conveyed into the calcined coal gangue product bin 11 through the chain plate conveyor 10 in sequence, The flue gas generated by the rotary kiln 7 is also drawn by the first flue gas pipeline 12-1 and the first fan 13-1, and is conveyed into the rotary kiln 7 for heating raw materials through the second flue gas pipeline 12-2. Meanwhile, the flue gas generated by the rotary kiln 7 is also drawn and conveyed into the pretreatment system through the third flue gas pipeline 12-3 and the second fan 13-2 to perform dehydrating and drying of the coal gangue raw materials. The flue gas generated by the rotary kiln 7 is conveyed into the third fan 13-3 through the first flue gas pipeline 12-1 and the fourth flue gas pipeline 12-4, and the collected flue gas is conveyed into the first cooler 8-1 for cooling, is conveyed into the bag-type dust collector 8-2 for dust removal, then is drawn and conveyed to the desulfurization and denitration system 8-3 for performing desulfurization and denitration through the sixth flue gas pipeline 12-6 and the fourth fan 13-4, and is exhausted by the chimney 8-4 through the seventh flue gas pipeline 12-7 and the fifth fan 13-5.

The technical solutions in the present disclosure are described below clearly and completely with reference to the accompanying drawings in the present disclosure, It is apparent that the described embodiments are merely part rather than all of the embodiments of the present disclosure. On the basis of the embodiments of the present disclosure, all other embodiments obtained by those of ordinary skill in the art without creative work fall within the scope of protection of the present disclosure.

### EMBODIMENT 1

Coal gangue is calcined by using the system as shown in FIG. 1. Specifically steps are as follows.

The HGI of the coal gangue is 51.5, the Ip is 10.5, and the calorific value is 519 kC/kg.

The coal gangue is conveyed to the pretreatment system 1 for performing dehydrating and drying, so as to obtain pretreated coal gangue and flue gas.

The pretreated coal gangue is conveyed into the raw material bin 2 for mixing, homogenizing, and storing to obtain homogenized coal gangue.

The homogenized coal gangue is conveyed to the feeding system (3) for metering through the belt conveyor 2-1, and then is conveyed into the hammer crusher 4 for crushing, so as to obtain crushed coal gangue.

The crushed coal gangue is conveyed into the flip-flow screen 5 for screening to obtain large size of coal gangue, medium size of coal gangue, and small size of coal gangue, wherein the particle size of the large size of coal gangue is greater than 25 mm, the particle size of the medium size of coal gangue is 0.5 to 25 mm, and the particle size of the small size of coal gangue is less than 0.5 mm. The large size of coal gangue is conveyed into the crusher for performing secondary crushing,

The medium size of coal gangue and the small size of coal gangue are mixed and elevated into the screw feeder 6-2 through the elevator 6-1 after being batched, and then the mixture enters the rotary kiln 7 for calcining, so as to obtain calcined coal gangue and flue gas.

The addition amount of the small size of coal gangue accounts for 85.5% of the total mass of the small coal gangue.

The length-to-diameter ratio of the rotary kiln 7 is 35, the rotating speed is 1.2 r/min, and ρ is 19%.

During calcination, first, the room temperature rises to 550° C. to heat the coal gangue, and the time is 22.5 min. Then, the temperature rises from 550° C. to 585° C. to convert and stabilize mineral substances in the coal gangue, and the time is 7.5 min. Calcination is performed for 55 min under the condition of 1050° C. Cooling is performed for 15 min under the condition of 580° C. During the calcination, the calcination medium is air, and the molar ratio of oxygen in the air to the content of fixed carbon in the coal gangue is 1.28:1, and the flowing speed of the air is 2.8 m/s.

(6) The calcined coal gangue is cooled through the second cooler 9 and is conveyed into the calcined coal gangue product bin 11 through the chain plate conveyor 10 in sequence, and detection is performed during conveying, so as to obtain the loss on ignition of the calcined coal gangue of 7.5%, which meets the quality index of the calcined coal gangue product.

(7) The flue gas generated in the rotary kiln 7 is also drawn by the first flue gas pipeline 12-1 and the first fan 13-1, and is conveyed into the rotary kiln 7 through the second flue gas pipeline 12-2 to heat raw materials. Meanwhile, the flue gas generated by the rotary kiln 7 is also drawn and conveyed into the pretreatment system for performing dehydrating and drying through the third flue gas pipeline 12-3 and the second fan 13-2. The flue gas generated by dehydrating and drying is conveyed into the third fan 13-3 through the fifth flue gas pipeline 12-5. The flue gas generated by the rotary kiln 7 is conveyed into the third fan 13-3 through the first flue gas pipeline 12-1 and the fourth flue gas pipeline 12-4. The collected flue gas is conveyed into the first cooler 8-1 to perform cooling, is further conveyed into the bag-type dust collector 8-2 to remove dust particles, and then is drawn and conveyed into the desulfurization and denitration system 8-3 for performing desulfurization and denitration through the sixth flue gas pipeline 12-6 and the fourth fan 13-4. The flue gas is exhausted into the environment through the chimney 8-4 through the seventh flue gas pipeline 12-7 and the fifth fan 13-5 after reaching a discharge standard.

### EMBODIMENT 2

The coal gangue is calcined according to the method of Embodiment 1. The differences from Embodiment 1 are as follows.

The HGI of the coal gangue is 55.0, the Ip is 12.6, and the calorific value is 650 kC/kg.

A hammer crusher is used in step (3).

A flip-flow screen is used for screening in step (4).

In step (5), the mass of the small size of coal gangue accounts for 66.5% of the total mass of the small size of coal gangue. The length-to-diameter ratio of the rotary kiln 7 is 37.5, the rotating speed is 1.5 r/min, and ρ is 22.5%. During calcination, the rotary kiln 7 is heated form room temperature to 550° C., and the time is 20 min. Then, the temperature rises from 550° C. to 660° C. to convert and stabilize mineral substances in the coal gangue, and the time is 6.5 min. Calcination is performed at the temperature of 950° C. for 60 min. Cooling is performed at 600° C. for 15 min. During the calcination, the molar ratio of oxygen in the air to the content of fixed carbon in the coal gangue is 1.30:1, and the flowing speed of the air is 2.5 m/s.

In step (6), the loss on ignition is 8.5%.

### EMBODIMENT 3

The coal gangue is calcined according to the method of Embodiment 1. The differences from Embodiment 1 are as follows.

The HGI of the coal gangue is 41.8, the Ip is 5.5, and the calorific value is 500 kC/kg.

An impact crusher is used in step (3).

A vibrating screen is used for screening in step (4).

In step (5), the mass of the small size of coal gangue accounts for 85% of the total mass of the small size of coal gangue. The length-to-diameter ratio of the rotary kiln 7 is 40, the rotating speed is 1.5 r/min, and ρ is 20%. During calcination, the room temperature rises to 550° C. to heat the coal gangue, and the time is 23 min. Then, the temperature rises from 550° C. to 700° C. to convert and stabilize mineral substances in the coal gangue, and the time is 7.5 min. Calcination is performed for 55 min under the condition of 1080° C. Cooling is performed for 15 min under the condition of 600° C. During the calcination, the molar ratio of oxygen in the air to the content of fixed carbon in the coal gangue is 1.35:1, and the flowing speed of the air is 2.8 m/s.

In step (6), the loss on ignition is 8%.

### EMBODIMENT 4

The coal gangue is calcined according to the method of Embodiment 1. The differences from Embodiment 1 are as follows,

The HGI of the coal gangue is 48.6, the Ip is 8.5, and the calorific value is 885 kC/kg.

An impact crusher is used in step (3).

A vibrating screen is used for screening in step (4).

In step (5), the addition amount of the small size of coal gangue is 0. The length-to-diameter ratio of the rotary kiln 7 is 42.5, the rotating speed is 1.5 r/min, and ρ is 16.5%. During calcination, the room temperature rises to 550° C. to heat the coal gangue, and the time is 25 min. Then, the temperature rises from 550° C. to 690° C. to convert and stabilize mineral substances in the coal gangue, and the time is 7 min. Calcination is performed at 980° C. for 60 min. Cooling is performed at 580° C. for 15 min. During the calcination, the molar ratio of oxygen in the air to the content of fixed carbon in the coal gangue is 1.35:1, and the flowing speed of the air is 2.5 m/s,

In step (6), the loss on ignition is 8.5%.

The foregoing descriptions are merely preferred implementation manners of the present disclosure. It should be noted that those of ordinary skill in the art may make a number of improvements and refinements without departing from the principle of the present disclosure. These improvements and refinements should also be regarded as the scope of protection of the present disclosure.

What is claimed is:

1. A system for calcining coal gangue, comprising a pretreatment system (1);
a crusher (4) with a feeding port communicated with a discharging port of the pretreatment system (1);
a screening system (5) with a feeding port communicated with a discharging port of the crusher (4);
an elevator (6-1) with a feeding port communicated with a medium size of coal gangue discharging port (5-1) and a small size of coal gangue discharging port (5-2) of the screening system (5);
a screw feeder (6-2) with a feeding port communicated with a discharging port of the elevator (6-1) ;
a rotary kiln (7) with a feeding port communicated with a discharging port of the screw feeder (6-2 ); and
an exhaust gas treatment system (8) with a flue gas inlet communicated with a flue gas outlet of the rotary kiln (7), wherein
the crusher (4) comprises a hammer crusher or an impact crusher;
the screening system (5) comprises a flip-flow screen or a vibrating screen; both the flip-flow screen or the vibrating screen are of double-layer screen mesh structures; the mesh size of an upper-layer screen of a double-layer screen mesh structure is 25 mm, and the mesh size of a lower-layer screen of the double-layer screen mesh structure is 0.5 mm.

2. The system according to claim 1, wherein the flue gas outlet of the rotary kiln (7) is communicated with each of the flue gas inlet of the rotary kiln (7) and the flue gas inlet of the pretreatment system (1); and
the length-to-diameter ratio of the rotary kiln (7) is 25 to 45.

3. The system according to either of claim 1, further comprising:
a first cooler (9) with a feeding port communicated with a discharging port of the rotary kiln (7);
a chain plate conveyor (10) with a feeding port communicated with a discharging port of the first cooler (9); and
a calcined coal gangue product bin (11) with a feeding port communicated a discharging port of the chain plate conveyor 10).

4. The system according to either of claim 2, further comprising:
a first cooler (9) with a feeding port communicated with a discharging port of the rotary kiln (7);
a chain plate conveyor (10) with a feeding port communicated with a discharging port of the first cooler (9); and
a calcined coal gangue product bin (11) with a feeding port communicated a discharging port of the chain plate conveyor (10).

5. The system according to claim 1, wherein the exhaust gas treatment system (8) comprises a second cooler (8-1), a bag-type dust collector (8-2) with a flue gas inlet communicated with the second cooler (8-1), a desulfurization and denitration system (8-3) with a flue gas inlet communicated with the flue gas outlet of the bag-type dust collector (8-2), a chimney (8-4) with a flue gas inlet communicated with the desulfurization and denitration system (8-3), and a dust bin (8-5) communicated with a discharging port of the bag-type dust collector (8-2); and a flue gas outlet of the cooler (8-1) is communicated with each of the flue gas outlet of the pretreatment system (1) and the flue gas outlet of the rotary kiln (7).

6. A method for calcining coal gangue by using the system according to claim 1, comprising the following steps:
conveying coal gangue to the pretreatment system (1) for performing pretreatment to obtain pretreated coal gangue;
conveying the pretreated coal gangue into the crusher (4) for crushing to obtain crushed coal gangue;
conveying the crushed coal gangue into the screening system (5) for screening to obtain large size of coal gangue, medium size of coal gangue, small size of coal gangue, wherein the particle size of the large size of coal gangue is greater than 25 mm, the particle size of the medium size of coal gangue is 0.5 to 25 mm, and the particle size of the small size of coal gangue is less than 0.5 mm; and
mixing the medium coal gangue and the small coal gangue through the elevator (6-1), and conveying the mixture to the screw feeder (6-2), and then calcining the mixture in the rotary kiln (7) to obtain calcined coal gangue and flue gas, wherein the flue gas is exhausted after being purified to reach a standard through the exhaust gas treatment system (8).

7. The method according to claim 6, wherein the flue gas outlet of the rotary kiln (7) is communicated with each of the flue gas inlet of the rotary kiln (7) and the flue gas inlet of the pretreatment system (1); and
the length-to-diameter ratio of the rotary kiln (7) is 25 to 45.

8. The method according to claim 6, further comprising
a first cooler (9) with a feeding port communicated with a discharging port of the rotary kiln (7);
a chain plate conveyor (10) with a feeding port communicated with a discharging port of the first cooler (9); and
a calcined coal gangue product bin (11) with a feeding port communicated a discharging port of the chain plate conveyor (10).

9. The method according to claim 7, further comprising:
a first cooler (9) with a feeding port communicated with a discharging port of the rotary kiln (7);
a chain plate conveyor (10) with a feeding port communicated with a discharging port of the first cooler (9); and
a calcined coal gangue product bin (11) with a feeding port communicated a discharging port of the chain plate conveyor (10).

10. The method according to claim 6, wherein the exhaust gas treatment system (8) comprises a second cooler (8-1), a bag-type dust collector (8-2) with a flue gas inlet communicated with the second cooler (8-1), a desulfurization and denitration system (8-3) with a flue gas inlet communicated with the flue gas outlet of the bag-type dust collector (8-2), a chimney (8-4) with a flue gas inlet communicated with the desulfurization and denitration system (8-3), and a dust bin (8-5) communicated with a discharging port of the bag-type dust collector (8-2); and
a flue gas outlet of the cooler (8-1) is communicated with each of the flue gas outlet of the pretreatment system (1) and the flue gas outlet of the rotary kiln (7).

11. The method according to claim 6, wherein the moisture of the pretreated coal gangue is less than or equal to 5%.

12. The method according to claim 7, wherein the moisture of the pretreated coal gangue is less than or equal to 5%.

13. The method according to claim 8, wherein the moisture of the pretreated coal gangue is less than or equal to 5%.

14. The method according to claim 9, wherein the moisture of the pretreated coal gangue is less than or equal to 5%.

15. The method according to claim 10, wherein the moisture of the pretreated coal gangue is less than or equal to 5%.

16. The method according to claim 6, wherein when the Hardgrove Grindability Index (HGI) of the coal gangue is greater than or equal to 50, the crusher (4) selects a hammer crusher; and
when the HGI of the coal gangue is less than 50, the crusher (4) selects an impact crusher.

17. The method according to claim 6, wherein when the index of plasticity (Ip) of the coal gangue is greater than 10, the screening system (5) selects a flip-flow screen; and when the Ip of the coal gangue is less than or equal to 10, the screening system (5) selects a vibrating screen.

18. The method according to claim 6, wherein ingredients are determined according to the calorific value of the coal gangue, which is as follows specifically:
when the calorific value of the coal gangue is 400 to 550 kC/kg, the addition amount of the small coal gangue accounts for 80 to 100% of the total mass of the small coal gangue;
when the calorific value of the coal gangue is 551 to 700 kC/kg, the addition amount of the small coal gangue accounts for 50 to 75% of the total mass of the small coal gangue;
when the calorific value of the coal gangue is 701 to 850 kC/kg, the addition amount of the small coal gangue accounts for 25 to 50% of the total mass of the small coal gangue; and
when the calorific value of the coal gangue is greater than 850 kC/kg, the addition amount of the small coal gangue is 0.

19. The method according to claim 6, wherein the calcination temperature is 950 to 1100° C., and the time is 50 to 65 min;
the calcination atmosphere is air, and the molar ratio of oxygen in the air to the content of fixed carbon in the coal gangue is (125 to 1.50):1;
the loss on ignition of the calcined coal gangue is less than or equal to 8.5%; and
a filling coefficient of the coal gangue in the rotary kiln is 12 to 25%.

20. The method according to claim 18, wherein the calcination temperature is 950 to 1100° C., and the time is 50 to 65 min;
the calcination atmosphere is air, and the molar ratio of oxygen in the air to the content of fixed carbon in the coal gangue is (125 to 1.50):1;
the loss on ignition of the calcined coal gangue is less than or equal to 8.5%; and
a filling coefficient of the coal gangue in the rotary kiln is 12 to 25%.
